(19) United States
(12) Patent Application Publication
(10) Pub. No.: US 2016/0031038 A1
(43) Pub. Date: Feb. 4, 2016

(54) Laser Processor and Laser Processing Method

(71) Applicant: MURATA MACHINERY, LTD., Kyoto-shi (JP)

(72) Inventors: Keita Matsumoto, Inuyama-shi (JP); Atsushi Nakamura, Inuyama-shi (JP)

(73) Assignee: MURATA MACHINERY, LTD., Kyoto-shi (JP)

(21) Appl. No.: 14/879,049

(22) Filed: Oct. 8, 2015

Related U.S. Application Data
(63) Continuation of application No. PCT/JP2014/056946, filed on Mar. 14, 2014.

(30) Foreign Application Priority Data
Apr. 17, 2013 (JP) 2013-086230

(51) Int. Cl. B23K 26/042

(52) U.S. Cl. CPC B23K 26/042

(57) ABSTRACT

A laser processing machine includes a first focal point change amount calculating unit for calculating the time difference between an irradiation period during which a laser beam is irradiated from a laser processing head and a down time, or calculating the amount of change in focal point position from a detected temperature of an optical system in its entirety. A second focal point change amount unit calculates the amount of change in focal point position relative to a temperature change of a protective glass. A focal point position correcting unit causes a processing machine main body control device to correct the focal point position with the use of the sum of the change amounts of focal point position calculated by the first and second focal point change amount calculating units.

### CROSS REFERENCE TO THE RELATED APPLICATION

This application is a continuation application, under 35 U.S.C. §111(a), of international application No. PCT/JP2014/056946, filed Mar. 14, 2014, which is based on and claims Convention priority to Japanese patent application No. 2013-086230, filed Apr. 17, 2013, the entire disclosure of which is herein incorporated by reference as a part of this application.

### BACKGROUND OF THE INVENTION

1. Field of the Invention

The present invention relates to a laser processing machine for performing, for example, a cutting process on a work such as a plate material and, particularly, to a laser processing machine and a laser processing method both having a function of accomplishing a focal point correction and the like applicable to dirt on the optical system.

2. Description of Related Art

The patent document 1 listed below, for example, discloses a conventional laser processing machine having a capability of correcting change of the focal point and laser processing, which change is brought about by the change in temperature rise in dependence on the extent of deterioration of a protective glass employed in a laser processing head. Specifically, in this known laser processing machine, the degree of dirt on the protective glass, for example, is detected with the use of a thermal detector or a light sensitive detector and the amount of change in focus is subsequently calculated from the temperature so detected, followed by correction of the focal point position. It is to be noted that an optical component of the laser processing head, if not contaminated, poses little problem associated with heat emission even though the laser beam passes through, but the presence of dirt on the optical component results in heat emission and, therefore, the temperature of the optical component increases.

### [Prior Art Literature]

Patent Document 1: JP Laid-open Patent Publication No. 2012-157893

In an optical system of the laser processing head, an optical element positioned closest to a processing point, such as a protective glass, is generally considered an easy site to be smeared, but change in focal point position resulting from a change in temperature rise is also found in any other optical element employed in the laser processing head. For this reason, mere correction of the focal point position through the temperature detection on the protective glass is insufficient. Also, the extent of temperature change occurring in the optical element closest to the processing point such as the protective glass and that of any other optical element are quite different from each other and, therefore, the correction of the focal point position in both of the optical elements cannot be accomplished merely with one detection value. If focal point position correction is individually performed by detecting respective temperatures of those different optical elements, the proper focal point position correction can be accomplished, but the number of sensors used in this case tends to become too many and, also, calculation for the correction becomes complicated.

According to the patent document 1 listed above, the temperature detected is utilized and the amount of change in focal point position is then calculated from the detected temperature to accomplish the correction of the focal point position. However, considering that during the usual processing the laser beams are repeatedly switched on and off, accompanied by variation of the laser output, a good, precise focal point position correction is generally difficult to achieve.

### SUMMARY OF THE INVENTION

In view of the foregoing, the present invention has for its primary object to provide a laser processing machine and a laser processing method capable of performing a proper correction of both of change of the focal point position, which results from the change in temperature rise brought about by, for example, contamination of the optical element closest to the processing point such as a protective glass, and the change of the focal point position which results from the change in temperature rise of any other optical components, which is effective to provide an excellent processing quality and in which the undesirable increase of the number of sensors and the complication of calculation can be suppressed.

Hereinafter, in order to facilitate the better understanding of the present invention, the present invention will be described using reference numerals employed in the accompanying drawings in embodiments of the present invention.

The laser processing machine designed in accordance with the present invention is a laser processing machine which comprises a laser processing head (4) having an optical system (15), including a plurality of optical elements, and a focal point position adjusting mechanism (16) for the optical system (15); a laser oscillator (5); a moving mechanism (6) to relatively move the laser processing head (4) relative to a work (W); and a control device (2) to control the focal point position adjusting mechanism (16), the laser oscillator (5) and the moving mechanism (6). The laser processing machine is operable to repeatedly switch-on and switch off of a laser beam irradiated upon the work. This laser processing machine further comprises a first focal point change amount calculating unit (35) to calculate the difference between an irradiation time and a down time of the irradiation of the laser beam from the laser processing head (4), or an amount of change in the focal point position from a detection value of a temperature of the optical system (15) as a whole; a second focal point change amount calculating unit (37) to calculate the amount of change in the focal point position from a detection value of the temperature of the optical element of the optical system (15), which is closest to a processing point, relative to a temperature change of the optical element closest to the processing point; and a focal point position correcting unit (25) to cause the control device (2) to correct the focal point position by means of the focal point position adjusting mechanism (16) with the use of the sum of the change amounts of the focal point position calculated by the first and second focal point change amount calculating units (35 and 37) respectively.

It is to be noted that the focal point position correcting unit (25) may be so designed and so configured that in consequence the correction is carried out with the use of the sum of the change amounts of the focal point position and, for example, as shown and described in connection with embodiments of the present invention, from the change amount of the focal point position calculated by the first and second focal point change amount calculating units (35 and 37) respectively, the correction amount, which is an amount to be moved from the current position for the respective change amounts, may be calculated and the control device (2) may cause the focal point position adjusting mechanism (16) to perform the correction by means of the adjustment of the focal point position in dependence on the sum of the correction amounts.

The optical element closest to the processing point may be a protective glass in the case of the solid state laser processing machine such as a fiber laser or a YAG laser, and a light collecting lens in the case of a gas laser processing machine such as CO₂ laser.

The present invention also provides a laser processing method which comprises a step of repeating switch-on and switch off of a laser beam irradiated upon a work with the use of a laser processing head having an optical system, including a plurality of optical elements and a focal point position adjusting mechanism for the optical system; a laser oscillator; a moving mechanism to relatively move the laser processing head relative to the work; and a control device to control the focal point position adjusting mechanism, the laser oscillator and the moving mechanism, which method includes:

a first focal point change amount calculating step to calculate the difference between an irradiation time and a down time of the irradiation of the laser beam from the laser processing head, or an amount of change in the focal point position from a detection value of a temperature of the optical system as a whole;

a second focal point change amount calculating step to calculate the amount of change in the focal point position from a detection value of the temperature of the optical element of the optical system, which is closest to a processing point, relative to a temperature change of the optical element closest to the processing point; and

a focal point position correcting step to cause the control device to correct the focal point position by means of the focal point position adjusting mechanism with the use of the sum of the change amounts of the focal point position calculated by the first and second focal point change amount calculating steps respectively.

According to the construction hereinabove described, since the use is made of the first focal point change amount calculating unit (35) to calculate the amount of change in the focal point position in dependence on the temperature of the optical system (15) in its entirety and the second focal point change amount calculating unit (37) to calculate the amount of change in the focal point position relative to the temperature change of the optical element (13) closest to the processing point and since with the use of the sum of the change amounts of the focal point position, calculated by the first and second focal point change amount calculating units (35 and 37), the correction of the focal point position by the adjustment of the focal point position adjusting mechanism (16) is carried out, the proper correction can be made to both of the change of the focal point position, resulting from the change in temperature rise of the optical element (13) such as a protective glass (13) closest to the processing point and susceptible to dirt and the change of the focal point position resulting from the change in temperature rise of any other optical components (11 and 12) and, hence, the excellent processing quality can be obtained.

Since the amount of change in the focal point position relative to the temperature of the optical system (15) in its entirety is carried out by collectively determining the amount of change in focal point position, not by performing the temperature detection of the individual optical elements, an undesirable increase of sensors and complication of the calculation can be suppressed advantageously.

It is to be noted that the amount of change in the focal point position relative to the temperature of the optical system (15) in its entirety may be calculated in dependence on the time difference between the irradiation time, during which the laser beam is irradiated, and the down time, besides the calculation thereof based on the detection value of the temperature. However, since the calculation is made in dependence on the time difference between the irradiation time and the down time, not solely on the irradiation time, even repetition of ON and Off of the laser beam radiation to the single work (W) makes it possible to properly estimate the temperature change in dependence on time. By estimating the temperature change in dependence on time, the use of the temperature detecting unit can be dispensed with and the number of component parts can therefore be reduced. With respect to time, since the calculation processing device is always equipped with a clock generating unit, clock pulses so generated can be utilized therefor.

With respect to the optical element (13) closest to the processing point, since it is susceptible to dirt and involves a considerable change in temperature, a detection value descriptive of the temperature is used in correcting the focal point position, not depending on the time, and proper correction of the focal point position can be carried out relative to the considerable temperature change.

In an embodiment of the present invention, a halt/correction determining unit (38) may be used to compare the detection value of the temperature of the optical element (13) closest to the processing point with a halt decision threshold value and a correction decision threshold value, in order to cause the control device (2) to halt a processing in the event of excess over the halt decision threshold value, in order to cause the focal point position correcting unit (25) to perform the correction in the event of an excess over the correction decision threshold value when it is lower than the halt decision threshold value, and in order to inhibit the focal point position correcting unit (25) from performing the correction using the amount of change in the focal point position calculated by the second focal point change amount calculating unit (25) in the event that it is lower than the correction decision threshold value.

If the temperature is too high to perform a proper processing, that is, if it exceeds the halt decision threshold value, the processing is halted so that, when the correction of the focal point position cannot be accommodated, the generation of a defective work (W) can be avoided. Also, if the temperature rise is small enough to be lower than the halt correction decision threshold value, for example, if the correction amount of the focal point position calculated by the detected temperature is lower than the resolution which can be adjusted with the focal point position adjustment mechanism (16), the focal point position correction unit (25) does not perform correction to avoid a futile calculation and also to avoid an instability incident to frequent correction calculations and, therefore, the futile focal point position correction can be eliminated.

In a further embodiment of the present invention, a processing adjustment command unit (39) may be used to perform at least one of an adjustment of a laser output by the laser oscillator (5) and an adjustment of a moving speed by the moving mechanism (6), in the event that the amount of change in the focal point position calculated by the second focal point change amount calculating unit (37) exceeds a processing adjustment decision threshold value.

In the event that the amount of change in focal point position is too large to make a proper correction of the focal point position appropriate to the amount of change thereof, generation of dross becomes excessive and, because of the insufficient output, the laser processing such as cutting will become impossible to accomplish. Even in this case, if the laser output is varied or the speed of relative movement between the work (W) and the laser processing head (4) is changed, the processing quality can be processed within a practically satisfactory range.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is an explanatory diagram comprised of a perspective view, showing a general outline of a laser processing machine according to an embodiment of the present invention, and a block diagram of the latter;

FIG. 2A is a schematic side view with a portion cut away showing a laser processing head of the laser processing machine in a normal condition;

FIG. 2B is a schematic side view with a portion cut away showing the laser processing head of the laser processing machine in a contaminated condition;

FIG. 3 is a block diagram showing a conceptual structure of the laser processing machine;

FIG. 4 is a block diagram showing another conceptual structure of the laser processing machine different from that of FIG. 3, which diagram is presented for the purpose of reference;

FIG. 5 is a flowchart showing the contents of a process of an entire optical system associated correction unit of the laser processing machine;

FIG. 6 is a flowchart showing the contents of a process of a protective glass associated correction unit of the laser processing machine;

FIG. 7 is a flowchart showing the contents of a process of a processing preparation unit of the laser processing machine;

FIG. 8 is a chart showing an example of the relationship between the irradiation time and the focal point change in the laser processing machine;

FIG. 9A is a chart showing a relationship of the coefficient relative to the time; and

FIG. 9B is an explanatory diagram used to show the relationship between the amount of focal point change and the amount of focal point correction.

### DESCRIPTION OF PREFERRED EMBODIMENTS

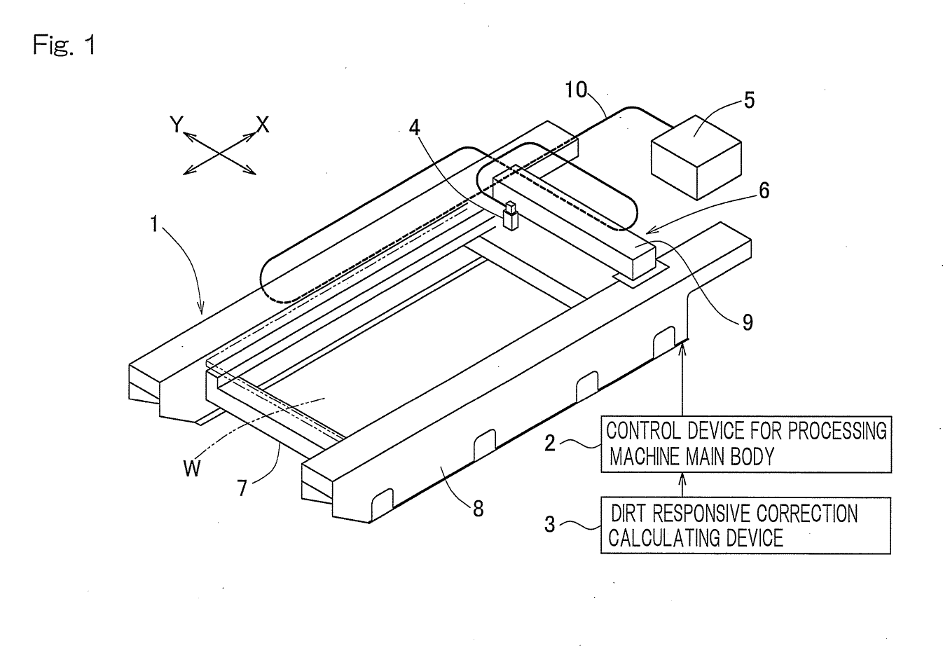

A laser processing machine and a laser processing method, which are herein provided in accordance with an embodiment, will now be described with particular reference to the accompanying drawings. As shown in FIG. 1, the laser processing machine operable to performing a laser cutting process or the like includes a processing machine main body 1, a control device 2 for the processing machine main body such as a numerically controlled device for controlling the processing machine main body 1, and a dirt responsive correction calculating device 3 characteristic of this embodiment to calculate the correction or such. The dirt responsive correction calculating device 3 conducts a command to coordinate correction or the like of the dirt on an optical system relative to the control device 2. This dirt responsive correction calculating device 3 may, however, be provided as a portion of the control device 2.

The processing machine main body 1 includes a laser processing head 4, a laser oscillator 5 and a moving mechanism 6 for relatively moving the laser processing head 4 relative to a work W. In the illustrated embodiment, the work W is rendered to be a stationary side whereas the laser processing head 4 is rendered to be a movable side, and the work W is placed on a work table 7. The work W is in the form of a rectangular plate material such as a steel plate. The moving mechanism 6 is of such a design that the laser processing head 4 is placed on a forward and rearward movable table 9, which is movable on a base table 8 in a forward and rearward direction (X-axis direction), movably in a leftward and rightward direction (Y-axis direction) through a leftward and rightward movable body (not shown), and is provided with a motor (not shown) for causing the movements in the forward and rearward direction, and the leftward and rightward direction. It is to be noted that the laser processing head 4 itself, or the leftward and rightward movable body supporting the laser processing head 4, may be provided with a mechanism (not shown) for elevating the laser processing head 4 in a direction vertical to an X-Y plane by means of a drive source (not shown). To the laser processing head 4, a laser beam oscillated by the laser oscillator 5 is sent through a laser beam transmitting path 10. The laser oscillator 5 may be either a solid state laser oscillator such as fiber laser, or a gas laser oscillator such as CO₂ laser, but in this embodiment is a solid state laser oscillator.

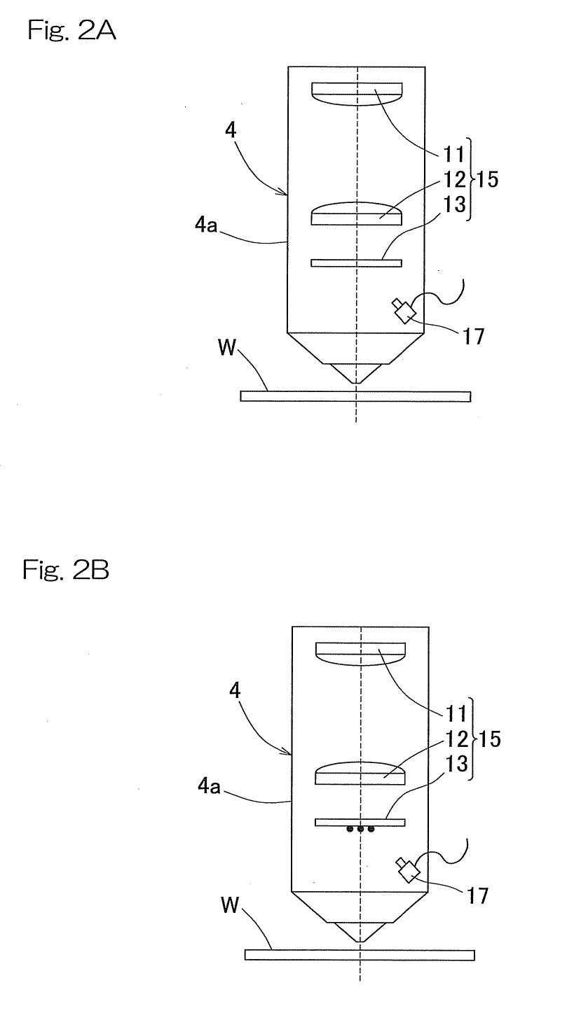

As shown in FIG. 2A, the laser processing head 4 includes a cylindrical casing 4a, within which a collimate lens 11 (which is a plurality of optical elements), a light collecting lens 12 and a protective glass 13 are accommodated while being arranged in this order from an upper side to a down side in the vertical direction relative to the X-Y plane. The collimate lens 11, the light collecting lens 12 and the protective glass 13, cooperate with each other to define an optical system 15 of the laser processing head 4. It is to be noted that in FIG. 2B, the protective glass 13 is shown in a condition with its surface smeared (with three dots).

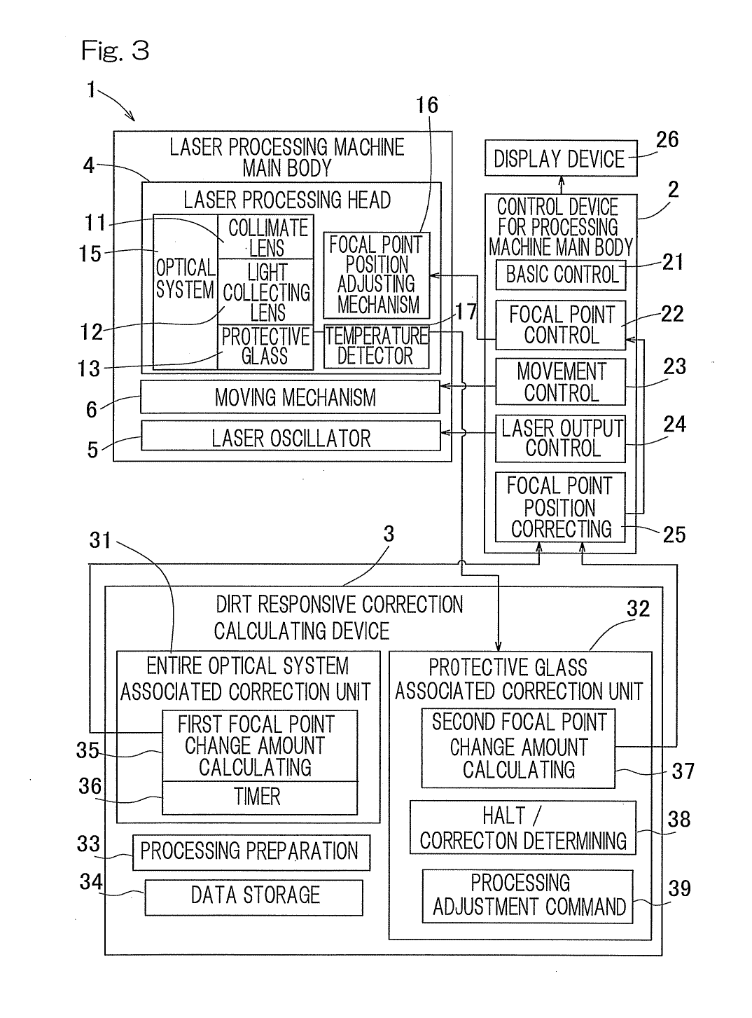

The laser processing head 4 is, besides the components referred to above, provided with a nozzle (not shown) for a processing gas (also referred to as an assist gas) and also provided with a focal point position adjusting mechanism 16 (shown in FIG. 3) for focusing the optical system 15, for example, the light collecting lens 12. This laser processing head 4 is provided with a temperature detector 17 for detecting the temperature of the protective glass 13. The temperature detector 17 is preferably of a type capable of accomplishing detection on non-contact and is employed in the form of, for example, a radiation thermometer.

Referring to FIG. 3, the control device 2 is made up of a computer type numerical control (NC) device, a programmable controller or the like and is operable to control the laser processing machine main body 1 in accordance with a processing program (not shown). The control device 2 includes, besides a basic control unit 21 for sequentially reading commands from the processing program and generating various commands corresponding to such processing program commands, a focal point control unit 22, a movement control unit 23 and a laser output control unit 24. The focal point control unit 22, the movement control unit 23 and the laser output control unit 24 control a focal point position adjusting mechanism 16, the moving mechanism 6 and the laser oscillator 5, respectively, in accordance with corresponding commands transmitted from the basic control unit 21 by means of control functions peculiar to those units 22 to 24. The focal point position correcting unit 25 is a unit for causing the focal point control unit 22 to perform the correction and a specific function thereof will be described later. The control device 2 is provided with an image display device 26 such as a liquid display device for displaying images.

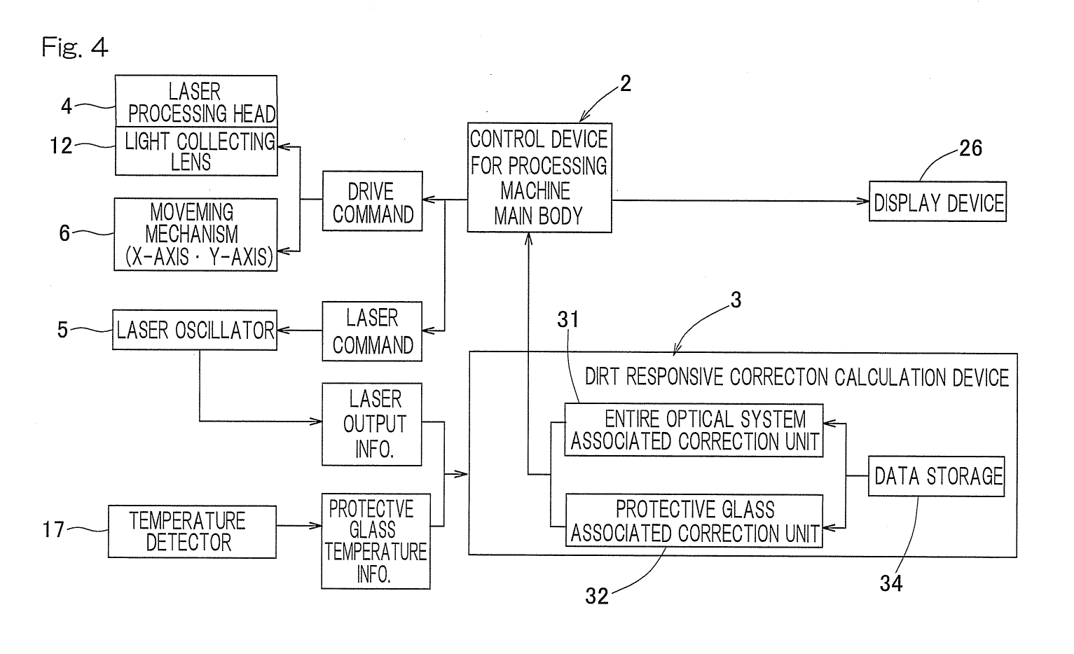

It is to be noted that FIG. 4 illustrates a block diagram showing the contents of FIG. 3 in simplified form for the purpose of reference.

Referring to FIG. 3, the dirt responsive correction calculating unit 3 is comprised of a personal computer or a microcomputer or the like that is connected with the control device 2 and includes an entire optical system associated correction unit 31, a protective glass associated correction unit 32, a processing preparation unit 33, and a data storage unit 34.

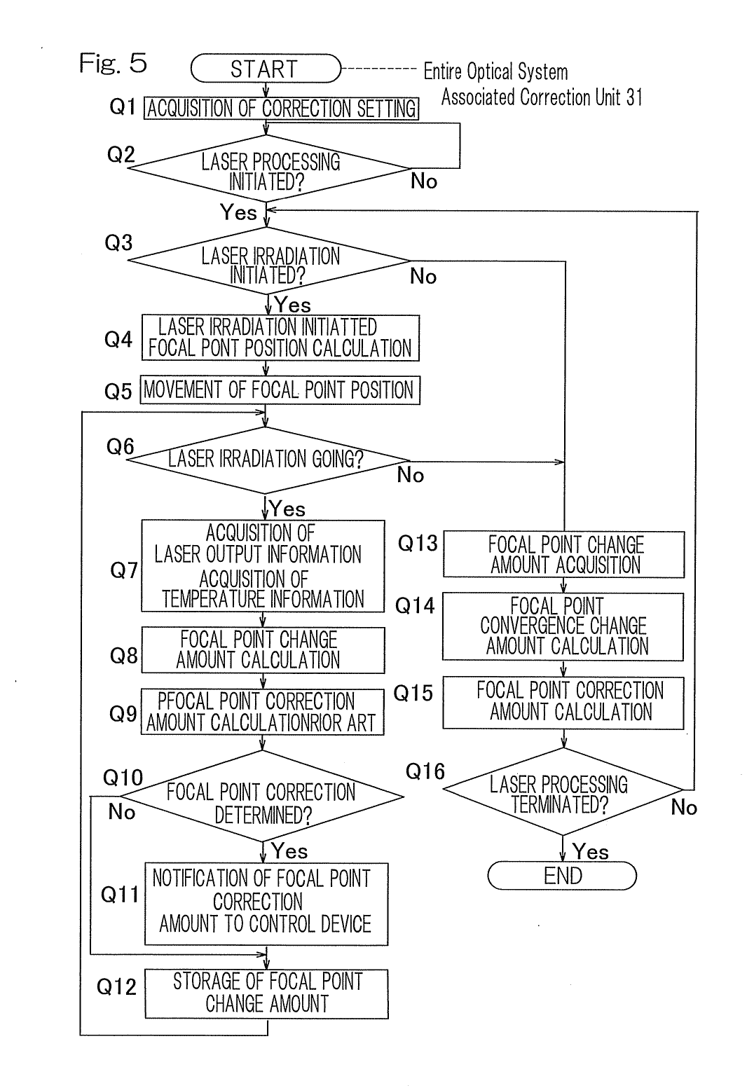

The entire optical system associated correction unit 31 is a unit capable of performing mainly a calculation of a correction amount for a temperature change in the entire optical system 15 and includes a first focal point change amount calculating unit 35 and a timer 36. The entire optical system associated correction unit 31 performs such a process shown by the flowchart of FIG. 5 in a manner as will be described in detail later.

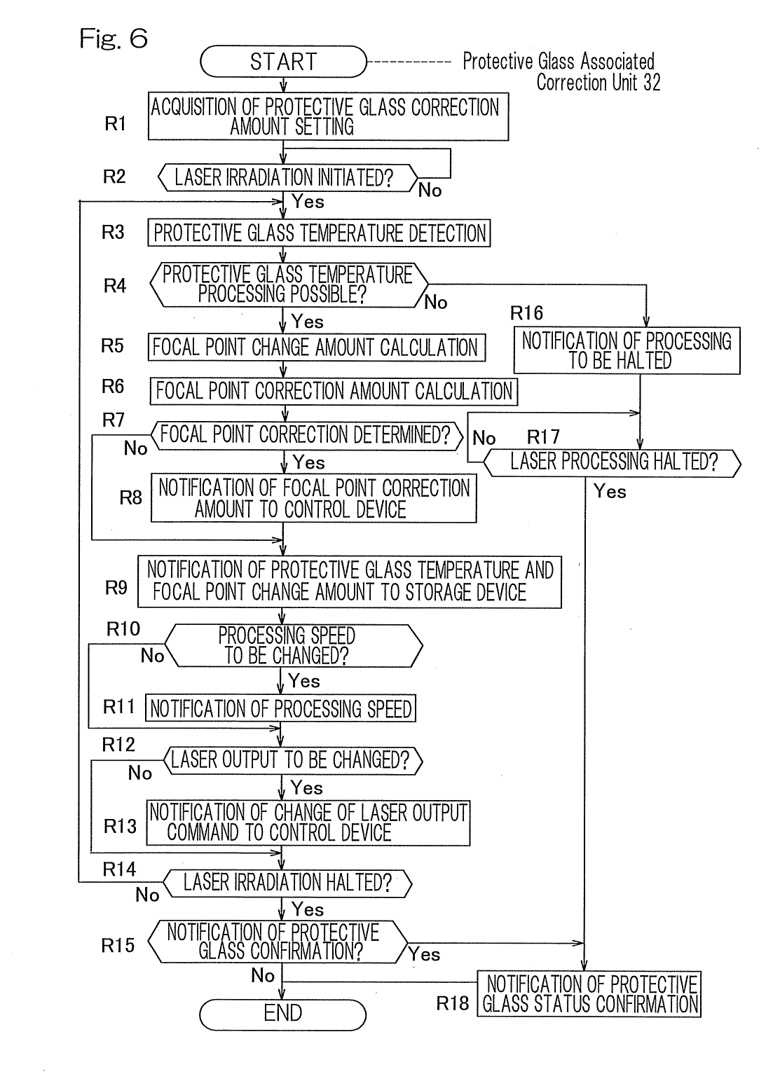

The protective glass associated correction unit 32 is capable of performing mainly a calculation of the correction amount for the dirt on the protective glass 13 and includes a second focal point change amount calculating unit 37, a halt/correction determining unit 38 and a processing adjustment command unit 39. This protective glass associated correction unit 32 performs such a process shown by the flowchart of FIG. 6 in a manner as will be described in detail later.

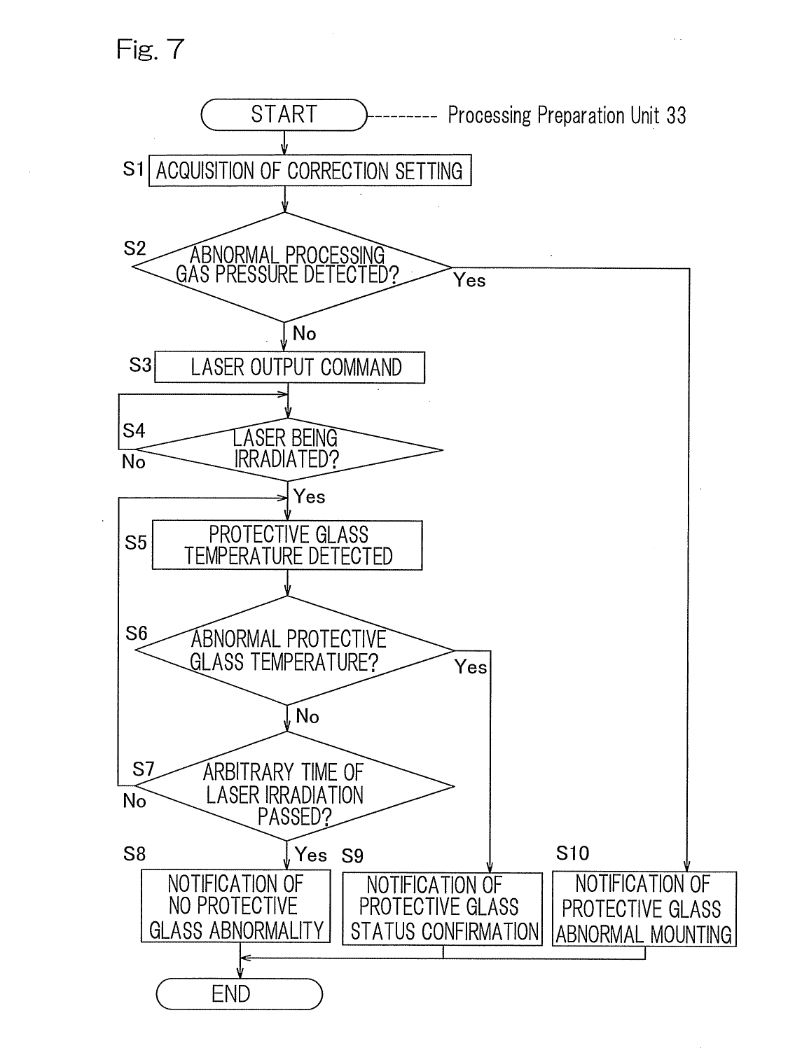

The processing preparation unit 33 irradiates an optical element (in this instance, the protective glass 13) closest to the processing point with a laser beam for a definite period of time prior to execution of the processing program, for comparing the temperature of the optical element, which is constantly measured, with a plurality of threshold values associated with predetermined temperatures, for making a decision as to whether or not the execution of the processing program can be terminated with a processing quality falling within a practically sufficient range, and for informing to the control device 2 of a status confirmation of the optical element such as the protective glass 13. Eventually, the processing preparation unit 33 performs such a process as shown in the flowchart of FIG. 7. It is to be noted that the control device 2 displays various notices, sent from the dirt responsible correction correcting device 3, on a screen of the display device 26.

The data storage unit 34 referred to above stores various data used in the calculation or the like of the correction amount.

The first focal point change amount calculating unit 35 in the entire optical system associated correction unit 31 calculates, according to a predetermined calculating equation, by way of example, the amount of change in the focal point position relative to the entire temperature change of the optical system 15 from the time difference between the irradiation time, during which the laser beam is irradiated from the laser processing head 4, and the down time. The amount of change in the focal point position so calculated is fed to the control device 2. The time difference between the irradiation time and the down time is counted with the use of the timer 36. It is, however, to be noted that in place of the time difference between the irradiation time and the down time, the amount of change in the focal position may be calculated from a detection value of the entire temperature of the optical system 15. The detection of the entire temperature of the optical system 15 is carried out by a temperature detector (not shown) installed on, for example, the laser processing head 4. This temperature detector measures the temperature of the optical system 15 as a whole, not the temperature of a portion of the optical element, and this is different from the temperature detector 17 used to measure the temperature of the protective glass 13.

The second focal point change amount calculating unit 37 in the protective glass associated correction unit 32 calculates, from a detection value of temperature of the optical element, i.e., the protective glass 13 in this instance, closest to the processing point in the optical system 15, according to a predetermined calculating equation, the amount of change in focal point position relative to the temperature change of the protective glass 13 which is the optical element referred to above. The second focal point change amount calculating unit 37 feeds the amount of change in focal point position as calculated, or the correction amount which will be described later and is determined from such amount of change in focal point position, to the control device 2. The detection value of temperature of the protective glass 13 is a detection value detected by the temperature detector 17 referred to previously.

The change amount or correction amount so calculated by the first and second focal point change amount calculating units 35 and 37 are fed to the control device 2 and, in the control device 2, the sum of the amounts of change in both of the focal point positions or the sum of the correction amounts of both of the focal point positions is calculated by the focal point position correcting unit 25 and, in dependence on the sum so calculated, the focal point position control unit 22 causes the focal point position adjusting mechanism 16 to perform the adjustment of the focal point position as a correction process.

As discussed above, since the amount of change in focal point position of the optical system 15 as a whole and the amount of change in focal point position of the protective glass 13 are calculated and, using the sum thereof, the adjustment or the correction of the focal point position is effected, a proper correction can be applied to both of the change in focal point position resulting from the change in temperature rise, which is caused by the dirt on the protective glass 13, which is the optical element closest to the processing point and susceptive to contamination, and the change in focal point position resulting from the change in temperature rise in any other optical components, and, therefore, an excellent processing quality can be obtained.

Since the amount of change in focal point position relative to the temperature of the optical system 15 in its entirety is carried out by collectively determining the amount of change in focal point position, not by performing the temperature detection of the individual optical elements, an undesirable increase of sensors and complication of the calculation can be suppressed advantageously. Since any other optical components are not so contaminated as compared with the protective glass 13, a practically sufficient correction of the focal point position can be accomplished even through the amount of change in focal point position relative to the collective temperature change is determined.

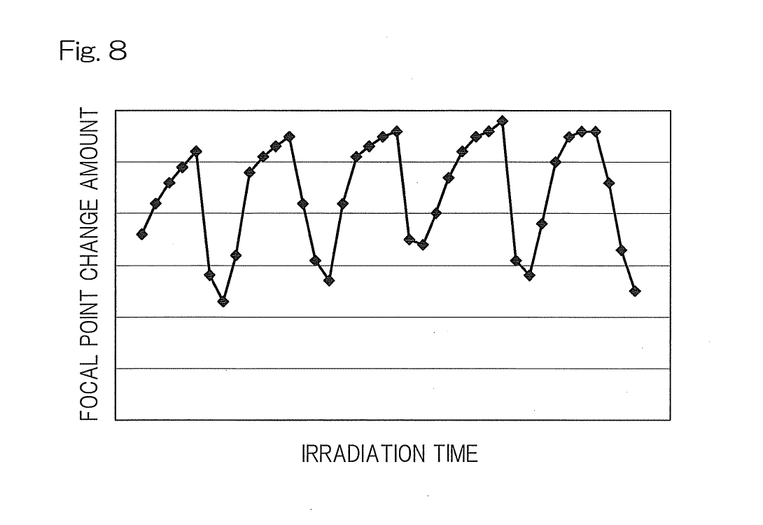

Although the amount of change in focal point position of the entire optical system 15 may be calculated in dependence on the time difference between the irradiation time, during which the laser beam is irradiated, and the down time, since the calculation is made in reference to the time difference between the irradiation time and the down time, not to the irradiation time alone, the temperature change can be properly estimated from the time even though the irradiation of one work W with the laser beam is repeatedly switched on and off. In other words, in a general laser cutting process of cutting a sheet metal, the laser beam is switched off each time the processing terminates, which is carried out with one time continuous irradiation such as cutting of, for example, an outer periphery of a component or cutting of an inner periphery of an opening. For this reason, where a process of cutting, for example, the work W, to the same shape is performed a number of times, the focal point position changes as shown in FIG. 8 each time the irradiation is switched off or on, if no correction of the focal point position is made. In contrast thereto, by performing the calculation with the use of the time difference between the irradiation time and the down time, the amount of change in focal point position of the optical system 15 as a whole can be accurately determined. Also, by estimating the temperature change and the change in focal point position from the switch-off and switch-on described above, the use of the temperature detecting unit can be dispensed with and the number of components used can therefore be reduced. With respect to the timer 36, if the structure is made in which the counting is accomplished with the use of a clock generating unit (not shown) equipped in a calculation processing device, no dedicated device is necessary.

With respect to the protective glass 13, which is an optical element positioned closest to the processing point, since the temperature change is large because it is susceptible to dirt, without relying on the time the use of the detection value of the temperature in the correction of the focal point position makes it possible to accomplish a proper correction of the focal point position relative to the large temperature change.

While the halt/correction determining unit 38 and the processing adjustment command unit 39 are basically such as hereinbefore described under the subtitle “Summary of the Invention”, a specific processing content thereof will be described later with particular reference to the flowchart of FIG. 6.

A specific function of the entire optical system associated correction unit 31 is described with particular reference to the flowchart of FIG. 5.

At step Q1, information necessary for the focal point correction such as threshold values and others is acquired, followed by step Q2 of waiting for a start command for initiation of the laser processing. The start command for initiation of the laser processing is a command to start the processing of one sheet of work W and is, for example, a start command to start a processing program.

Subsequently, initiation of the laser irradiation is waited for at step Q3. Once the start command is inputted, the laser irradiation is initiated to calculate the focal point position at step Q4, followed by step Q5 at which movement towards such focal point position is caused by the focal point position adjusting mechanism 16. The focal point position at this time is a position before the focal point correction.

A decision of whether or not the laser beam is being irradiated takes place at step Q6 and, if under processing, a value of the laser output, which is oscillated from the laser oscillator 5, and temperature information of the entirety of the optical system 15 are acquired at step Q7. This temperature information is information descriptive of the difference between the ON time of the laser irradiation and the OFF time of the laser irradiation or, if the temperature detection of the entirety of the optical system is carried out, the detected temperature value thereof. From the temperature information and the laser output information, both so obtained, the focal point position change amount resulting from the temperature change of the entirety of the optical system 15 is calculated at step Q8 and, at subsequent step Q9, the focal point correction amount necessary to correct the focal point change amount is calculated.

It is to be noted that, where the amount of change in the focal point position from the difference between the ON time and the OFF time referred to above is calculated, the calculation is carried out with the following equation:

(Focal Point Change Amount)=(Coefficient)×Laser Output(ON Time−Off Time)

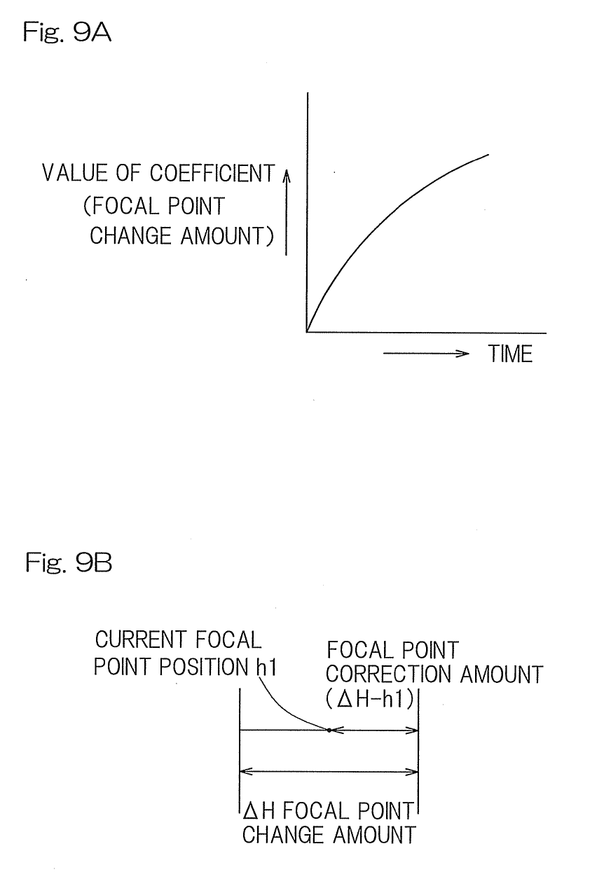

The coefficient in the equation above is a function of time that varies with, for example, time t as shown in FIG. 9A.

Also, at step Q9 at which the focal point correction amount is calculated, assuming that the current focal point position is h1 relative to the focal point change amount ΔH, the focal point correction amount is rendered to be (ΔH−h1) and varies depending on the current focal point position as shown in FIG. 9B.

After the focal point change amount has been calculated in the manner described above, a decision in reference to a predetermined standard is made at step Q10 to determine whether or not the focal point correction is to be performed. If the focal point correction is to be done, the focal point correction amount is fed to the control device 2 at step Q11. After the focal point correction amount has been fed, the focal point correction amount, for example, the focal point correction amount so fed or the focal point change amount is stored in a predetermined storage area at step Q12. With respect to the decision at step Q10 to determine whether or not the focal point correction is to be performed, if, for example, as a result of comparison of the change amount with a correction determination threshold value, the decision is made not to perform the correction when the change amount is too small to affect the processing quality. In such case, without conducting the feed of the focal point change amount to the control device 2 at step Q11, the storage of the focal point change amount takes place at step Q12.

After this storage, the program flow returns to the decision step Q6 to thereby repeat the previously described program steps. In other words, during the laser irradiation, the calculation at step Q8 to calculate the focal point change amount according to the temperature change of the entirety of the optical system 15 at full time is repeated.

If the laser irradiation is decided at the decision step Q6 as not taking place, the focal point change amount is acquired at step Q13, and the focal point convergence change amount is calculated at step Q14, followed by the calculation of the focal point correction amount at Q15. Another decision to determine whether or not the laser processing is completed is then made at step Q16. If the laser processing has not yet completed, the program flow goes back to the decision step Q3 to determine whether or not the initiation of the laser irradiation takes place.

If, as a result of the decision step at Q3, the initiation of the laser irradiation has not yet taken place, the program flow goes to step Q13, and then, the program flow up to the step Q16 takes place again. In this way, the acquisition of the focal point change amount at step Q13, the calculation of the focal point convergence change amount at step Q14, the calculation of the focal point correction amount at step Q15 and the decision step at Q16 are sequentially repeated when processing of the next portion in the same work W is initiated.

With reference to the flowchart of FIG. 6, the specific function of the protective glass associated correction unit 32 is described.

At step R1, various preset values such as a threshold value for the correction to the protective glass 13 are acquired. Subsequently, a wait for the initiation of the laser irradiation is made at step R2, and, once the laser irradiation is initiated, the temperature of the protective glass 13 is detected by the temperature detector 17 at step R3. The protective glass temperature so detected is compared with a halt decision threshold value at step R4. If it exceeds this threshold value, a notice to halt the processing is sent to the control device 2 at step R16 and, after the laser processing is halted at step R17, a notice of a protective glass status confirmation is sent to the control device 2 at step R18.

In the event that, as a result of comparison of the halt decision threshold value with the protective glass temperature at step R4, the processing is determined possible, step R5 at which the calculation of the focal point change amount is carried out by the second focal point change amount calculating unit 37, and step R6 at which the calculation of the focal point correction amount is carried out, take place successively, and, at step R7, a decision is made to determine whether or not the focal point correction is carried out. This decision is a decision to determine whether or not it is the moving amount that can be adjusted as is the case with the preciously described step (Q10 shown in FIG. 5) in which comparison is made with the correction decision threshold value. In the case that the focal point change amount is higher than the correction decision threshold value, it means that the focal point correction should be carried out, and the focal point correction amount is notified to the control device 2 at step R8. But if the focal point correction is not carried out, without issuing this notice, the protective glass temperature and the focal point change amount are notified to the storage device at step R9.

The halt/decision unit 38 shown in FIG. 2 and described previously is constituted by portions for executing a part of the program flows ranging from step R3 to step R8 and step R16.

After this notice at step R9, a decision is made at step R10 concerning a preset condition of a change determination of the processing speed. The processing speed is a speed of a relative movement between the laser processing head 4 and the work W that is effected by the moving mechanism 6. The preset condition is, for example, a processing adjustment decision threshold value for the processing speed change or a value of the laser beam output. When meeting the preset condition, a notice of the processing speed calculated according to a predetermined condition is fed to the control device 2 at step R11. In response to this notice, the control device 2 controls the movement control unit 23 to cause the moving mechanism 6 to change the moving speed as notified.

After the notice of the processing speed at step R11, or, in the event that the processing speed is not changed, after the decision at step R10 to determine whether or not the processing speed is to be changed, a decision is made at step R12 to determine whether or not the laser beam output is to be changed. It may occur that when the processing speed is changed, corresponding change of the laser beam output may be required. It may also occur that even though the change of the focal point position of the protective glass 13 may not be done to a proper value and the focal distance is not proper, the processing is possible if the laser beam output is changed. For such case a processing adjustment decision threshold value for the laser beam output change, which is the threshold value used in the decision, is set, and in the event that it exceeds the processing adjustment decision threshold value, a notice of a laser beam output command change is fed to the control device 2 at step R13. The control device 2, in response to this notice, causes the laser output control unit 24 to enable the laser oscillator 5 to effect a change to the laser beam output appropriate to such notice. It is to be noted that the processing adjustment command unit 39 shown in FIG. 2 and referred to above is constituted by portions for executing another part of the program flow ranging from step R10 to R13.

After the notice to change the laser beam output at step R13, or after the decision step R12 if such change is not done, a decision to halt the laser beam irradiation is carried out at step R14 and, by the time the laser beam irradiation is halted, the program flow return to the temperature detection of the protective glass at step R3, followed by repletion of the subsequent steps.

In the event that the laser beam irradiation is halted, after a decision at step R15 to determine whether or not a notice of a protective glass confirmation is to be performed in dependence on a preset condition, the notice of the protective glass confirmation is issued to the control device 2 at step R18 in the event of meeting with the condition, or straightforwardly, if it does not meet with the condition, a series of controls for the protective glass associated correction is terminated.

A specific function of the processing preparation unit 33 is hereinafter described in detail with reference to FIG. 7.

At step S1, a processing gas is switched on and an abnormality in the processing gas pressure is determined at step S2 because in the event that any abnormality occurs in mounting the protective glass 13, the processing gas pressure becomes abnormal and the proper processing is no longer carried out. In the event of the abnormality, a notice of the abnormality occurring in mounting of the protective glass 13 is issued at step S10, followed by termination of a processing preparation process.

In the event of no abnormality occurring, a command for laser output is carried out at step S3, a wait is made at step S4 before the initiation of the laser beam irradiation, and detection of the protective glass temperature takes place at step S5. The protective glass temperature is compared with a threshold value at step S6 and, in the event of determination of the abnormality, a notice of confirmation of the protective glass status is fed to the control device 2, followed by termination of the processing preparation process.

In the event of no abnormality occurring in the protective glass temperature, a decision is made at step S7 to determine whether or not an arbitrarily preset time or a predetermined time has passed subsequent to the initiation of the laser beam irradiation, and, by the time it passes, the program flow goes back to the protective glass temperature detecting step S5 with the successive steps from S5 to S7 repeated. If the arbitrarily preset time has passed subsequent to the initiation of the laser beam irradiation, a notice that the protective glass is free from any abnormality is fed to the control device 2 at step S8, followed by termination of the processing preparation process. By executing a series of processing preparation process steps in the manner described above prior to the actual processing, an undesirable occurrence of processing defects in the work W during the actual processing can be avoided beforehand.

While in describing the embodiment of the present invention, reference has been made to the solid state laser, the present invention can be equally applied to a gas laser such as CO₂ laser.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed within the scope of the present invention.

### REFERENCE NUMERALS

1 Processing machine main body
2 Control device for processing machine main body
3 Dirt responsive correction calculating device
4 Laser processing head
5 Laser oscillator
6 Moving mechanism
11 Collimate lens (Optical element)
12 Light collecting lens (Optical element)
13 Protective glass (Optical element)
15 Optical system
16 Focal point position adjusting mechanism
17 Temperature detector
25 Focal point position correcting unit
31 Entire optical system associated correction unit
32 Protective glass associated correction unit
33 Processing preparation unit
35 First focal point change amount calculating unit
37 Second focal point change amount calculating unit
38 Halt/correction determining unit
39 Processing adjustment command unit
W Work

What is claimed is:

1. A laser processing machine being operable to repeat switch-on and switch off of a laser beam irradiated upon a work, comprising:
a laser processing head having an optical system, including a plurality of optical elements, and a focal point position adjusting mechanism for the optical system;
a laser oscillator;
a moving mechanism to relatively move the laser processing head relative to the work;
a control device to control the focal point position adjusting mechanism, the laser oscillator and the moving mechanism;
a first focal point change amount calculating unit to calculate a difference between an irradiation time and a down time of irradiation of the laser beam from the laser processing head, or an amount of change in a focal point position from a detection value of a temperature of the optical system as a whole;
a second focal point change amount calculating unit to calculate an amount of change in the focal point position from a detection value of the temperature of an optical element of the optical system, which is closest to a processing point, relative to a temperature change of an optical element closest to the processing point; and
a focal point position correcting unit to cause the control device to correct the focal point position by means of the focal point position adjusting mechanism with use of a sum of change amounts of the focal point position calculated by the first and second focal point change amount calculating units.

2. The laser processing machine as claimed in claim 1, further comprising a halt/correction determining unit to compare the detection value of the temperature of the optical element closest to the processing point with a halt decision threshold value and a correction decision threshold value, in order to cause the control device to halt a processing in the event of excess over the halt decision threshold value, in order to cause the focal point position correcting unit to perform the correction in the event of an excess over the correction decision threshold value when it is lower than the halt decision threshold value, and in order to inhibit the focal point position correcting unit from performing the correction using the amount of change in the focal point position calculated by the second focal point change amount calculating unit in the event that it is lower than the correction decision threshold value.

3. The laser processing machine as claimed in claim 1, further comprising a processing adjustment command unit to perform at least one of an adjustment of a laser output by the laser oscillator and an adjustment of a moving speed by the moving mechanism, in the event that the amount of change in the focal point position calculated by the second focal point change amount calculating unit exceeds a processing adjustment decision threshold value.

4. A laser processing method which comprises a step of repeating switch-on and switch off of a laser beam irradiated upon a work, with the use of a laser processing head having an optical system including a plurality of optical elements and a focal point position adjusting mechanism for the optical system; a laser oscillator; a moving mechanism to relatively move the laser processing head relative to the work; and a control device to control the focal point position adjusting mechanism, the laser oscillator and the moving mechanism, the method further comprising:
a first focal point change amount calculating step to calculate a difference between an irradiation time and a down time of the irradiation of the laser beam from the laser processing head, or an amount of change in the focal point position from a detection value of a temperature of the optical system as a whole;
a second focal point change amount calculating step to calculate the amount of change in the focal point position from a detection value of the temperature of the optical element of the optical system, which is closest to a processing point, relative to a temperature change of the optical element closest to the processing point; and
a focal point position correcting step to cause the control device to correct the focal point position by means of the focal point position adjusting mechanism with the use of a sum of change amounts of the focal point position calculated by the first and second focal point change amount calculating steps.
